(19) United States
(12) Patent Application Publication
(10) Pub. No.: US 2005/0201423 A1
(43) Pub. Date: Sep. 15, 2005

(54) Control and compensation method for laser outputting

(75) Inventor: Jin Sheng Lai, Hsi Chih City (TW)

Correspondence Address: DENNISON, SCHULTZ, DOUGHERTY & MACDONALD, 1727 KING STREET, SUITE 105, ALEXANDRIA, VA, 22314, US

(73) Assignee: GREAT COMPUTER CORP.

(21) Appl. No.: 10/798,868

(22) Filed: Mar. 12, 2004

(51) Int. Cl. H01S 3/10

(52) U.S. Cl. 372/9

(57) ABSTRACT

A control and compensation method for laser outputting is used to compensate power of laser outputting within an unstable working area for obtaining consistence of energy same as the state in a stable working area, and is characterized by that: before laser outputting, a short pulse is used to energize laser to increase reaction speed of the laser; and an unstable working area thereafter is divided into several sections, each section represents a reaction time value, and a table is used to record compensation power value required for each corresponding reaction time value; so that when the laser outputting is within said unstable working area, its power is compensated in reference to the table for various positions of the sections. Thereby the pulse energy can be averagely controlled to get a good output power, the method is applicable to various laser-outputting equipment for reducing operation of adjustment.

### BACKGROUND OF THE INVENTION

1. Field of the Invention

The present invention is related to a control and compensation method for laser outputting, and especially to a laser-outputting control and compensation method in which the pulse energy can be averagely controlled to get a good output power, the method is applicable to various laser-outputting equipment for reducing operation of adjustment.

2. Description of the Prior Art

The basic principle of laser machine mainly is to guide and focus a laser beam on a surface to be processed. The focused laser beam is absorbed by material, thereby temperature is suddenly raised to create gasification, and the surface of an article is dented to get an object of carving and cutting. Using laser processing for carving and cutting is very simple; it looks like printing on papers using a computer and a printer. A variety of graphic processing software, such as CorelDraw, under the environment of Win 95/98 for designing, graphics scanned, vectorized graphics and characters and various CAD documents can all be easily “printed” in a carving machine. The only difference is that normal printing applies graphite powder onto papers, while optic laser carving direct outputs the laser beams onto almost all the materials including wooden articles, acryl material, plastic plates, metallic plates and stones.

Whether it is for the usage of carving or cutting, a laser tube provided in the laser machine shall be warmed up for a period of time after being turning on. When in processing, generally we hope an ideal laser processing machine can be activated at any time desired, no matter how long it has been interrupted, and the outputting power of the machine can be always kept constant and stable. However in fact, the thing is not like this, this is because that even a normal laser tube has been preheated, when it is to reactivate after stopping, we are unaware of that when the outputting power will be raised to a stable state; moreover, the components of an outputting graphic are not all continuous lines or planes, there really are many interrupted points, and the construction of the graphic will also have some gray levels, deep and shallow tints, so that the output of the laser tube often gets a state of non-stop on/off, that is, most processing actions are within the unstable positions in the drawing, if no good control can be obtained, the entire graphic output will be affected.

Referring to FIG. 5, for example, the four points C1-C4 in the graphs of a computer file are completely identical originally, when at the initial low state A, the energy of output is weaker, so that the point C1 can not be revealed at all, while the point C2 is too shallowly dotted, and later on when goes to a high state B, the energy of output is too strong and makes the point C3 too deep, till the last point C4, a normal power can only be obtained; such a defect can be overcome with a laser tube with better linear processing character; but a better laser tube costs quite expensive, it will increase the cost of production, and even if it is adopted, the effect thereof still can not completely get the aforesaid ideal state.

And more, conventional laser equipment often leads to non constant phenomenon of energy outputting by time difference in outputting and reaction; it will have a problem of non consistence of deep and shallow tints. And thereby it needs to provide a set of specific adjusting system to meet various random functions of carving and cutting etc.; this makes extreme inconvenience in use.

### SUMMARY OF THE INVENTION

The primary object of the present invention is to provide a control and compensation method for laser outputting to get a good outputting power when in outputting laser by averagely controlling pulse energy.

Another object of the present invention is to provide a control and compensation method that suits various laser tubes for reducing operation of adjustment and is very convenient and cost saving.

To achieve the above objects, the control and compensation method in laser outputting of the present invention is characterized by that: before laser outputting, a short pulse determined is used to energize the laser to increase the reaction speed of the laser; and an unstable working area thereafter is divided into several sections, each section represents a reaction time value, and a table is used to record the compensation power value required for each corresponding reaction time value; so that when the laser outputting is within the unstable working area, its power can be compensated in reference to the reference table for various positions of sections.

Thereby the pulse energy can be averagely controlled to get a good output power, the method suits various laser-outputting equipment for reducing operation of adjustment.

The present invention will be apparent after reading the detailed description of the preferred embodiment thereof in reference to the accompanying drawings.

### BRIEF DESCRIPTION OF THE DRAWINGS

FIG. 1 is a flow chart of the present invention;

FIG. 2 is a schematic view showing an unstable working area of an embodiment of the present invention is divided into 32 sections;

FIG. 3 shows a table provided for the embodiment of the present invention;

FIG. 4 is a flow chart of the entire system of the present invention in use;

FIG. 5 is a schematic view showing image outputting of a conventional laser equipment.

### DETAILED DESCRIPTION OF THE PREFERRED EMBODIMENT

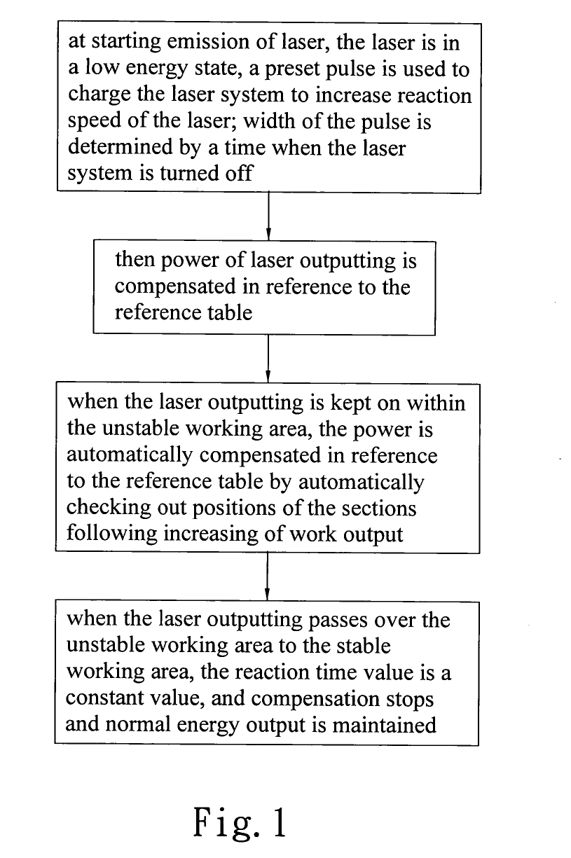

Referring to FIGS. 1-3, the control and compensation method for laser outputting of the present invention is mainly a method to compensate the laser outputting power in an unstable working area 1 for obtaining consistence of energy same as the state in a stable working area. The method is characterized by that: to divide the unstable working area 1 into several sections, each section represents a reaction time value, and a table is used to record the compensation power value required for each corresponding reaction time value; so that when the laser outputting is within the unstable working area, its power can be compensated in reference to the reference table for various positions of sections.

Thereby pulse energy can be averagely controlled to get a good output power; the method suits any laser-outputting equipment for reducing operation of adjustment.

In using, the processing actions of all stages are as below:
a. Before starting emission of laser, the laser is in a low energy state, a preset pulse is used to charge the laser system to increase the reaction speed of the laser; the width of the pulse is determined by the time when the laser system is turned off and the characteristic of the laser.
b. Then the power of the laser outputting is compensated in reference to the reference table.
c. When the laser outputting is kept on within the unstable working area 1, the power can be automatically compensated in reference to the reference table by automatically checking out the positions of the sections following increasing of work output.
d. When the laser outputting passes over the unstable working area 1 to the stable working area 2, its reaction time value is a constant value, and compensation will stop and normal energy output is maintained.

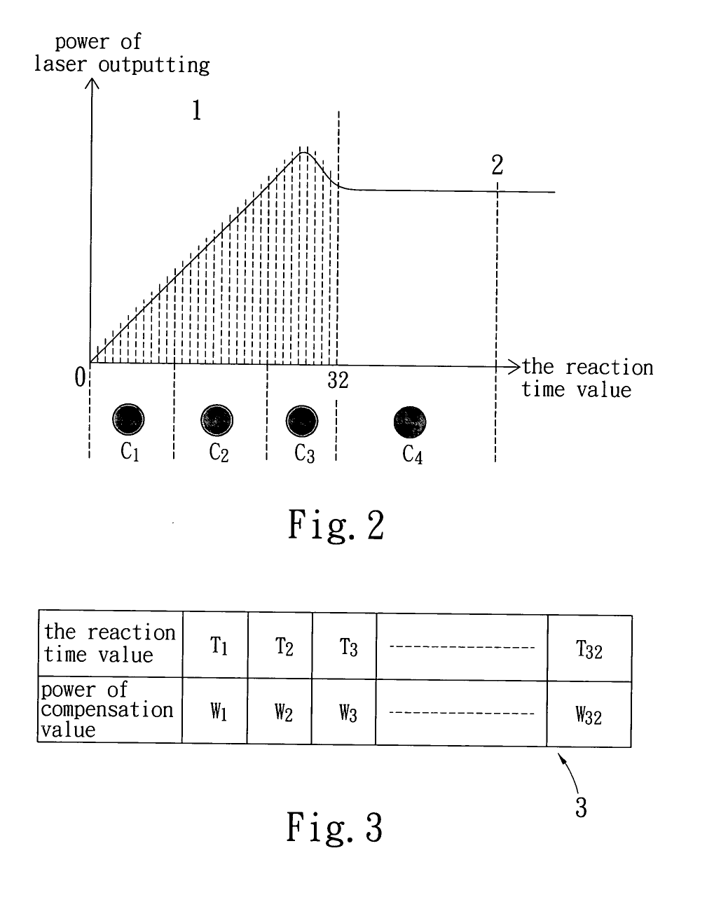

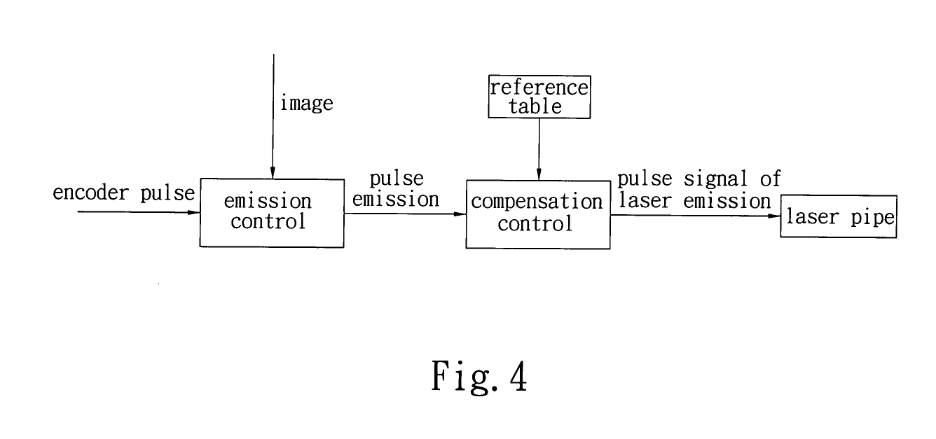

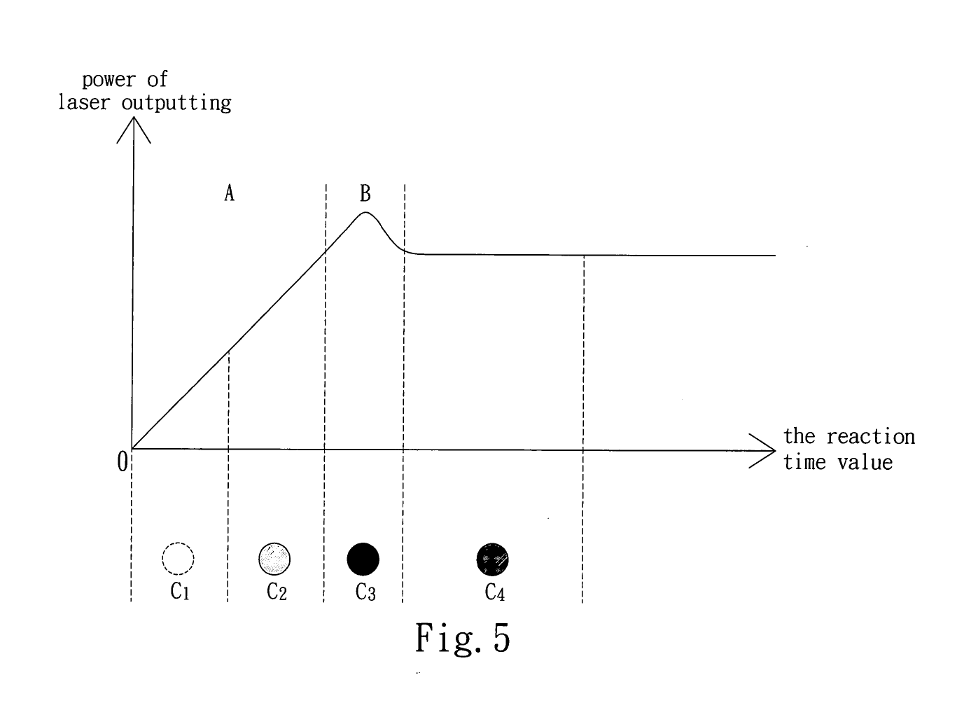

Referring to FIGS. 2 and 3, taking the case that an unstable working area of an embodiment of the present invention is divided into 32 sections as an example, each section represents a reaction time value, and a table 3 is used to record the compensation power value required for each corresponding reaction time value; so that a result of stable output can be obtained when each reaction time output is added with its compensation value. The entire systematic flow chart is as depicted in FIG. 4, the pulse signal of laser output is sent to the laser tube after control of emission to check encoder pulse and image and then to compensate the required power through referencing to the table 3 by compensation control.

Thereby when in performing laser output operation (at this time, the laser outputting is within the unstable working area 1 after preset pulse is performed as set a.), its output increases continuously; the power in each section can be compensated in reference to the reference table 3 automatically following changing of reaction time value in the section, so that pulse energy within the unstable working area 1 can be averagely controlled to get a good output power. When the laser outputting passes over the unstable working area 1 to the stable working area 2, its reaction time value is a constant value, and compensation will stop and normal energy output is maintained. Therefore, no matter the laser outputting is within the unstable working area 1 or the stable working area 2, the points C1-C4 dotted by the laser outputting can both be very good and stable. By the same reason, when the laser is reactivated after it finishes outputting within the stable working area 2, its reaction time value of outputting is set to zero; the system will repeat the aforesaid process flow and makes compensation of power in reference to the reference table.

Therefore, the present invention includes the following advantages:
1. The control and compensation method for laser outputting of the present invention can immediately make compensation of power for different sections during laser outputting, thereby pulse energy can be well controlled to get a stable output power.
2. The control and compensation method for laser outputting of the present invention is suitable for various laser tubes and all can get their good output effects, no expensive laser tube is required, and cost can be largely lowered; and adjustment step by step during mounting can be reduced, it suits various machine of different functions, thereby is very convenient.

In conclusion, the present invention surely can get its expected objects to provide a control and compensation method for laser outputting, it is industrially valuable.

1. A control and compensation method for laser outputting, said method is used to compensate power of laser outputting within an unstable working area for obtaining consistence of energy same as a state in a stable working area, said method is characterized by that: before laser outputting, a short pulse by the table indexed by laser off time is used to energize laser to increase reaction speed of said laser; and an unstable working area thereafter is divided into a plurality of sections, each of said sections represents a reaction time value, and a reference table is used to record compensation power value required for each corresponding one of said reaction time values; so that when said laser outputting is within said unstable working area, its power is compensated in reference to said reference table for various positions of said sections.

2. The control and compensation method for laser outputting as in claim 1, wherein said unstable working area is divided into n sections (n is an integer larger than 1).

3. The control and compensation method for laser outputting as in claim 1, wherein said compensation power value is determined in corresponding to one of said reaction time values.

4. The control and compensation method for laser outputting as in claim 1, wherein
a. upon starting emission of said laser, said laser is in a low energy state, a preset pulse is used to charge said laser system to increase reaction speed of said laser; width of said pulse is determined by a time when said laser system is turned off;
b. then power of said laser outputting is compensated in reference to said reference table;
c. when said laser outputting is kept on within said unstable working area, said power is automatically compensated in reference to said reference table by automatically checking out positions of said sections following increasing of work output;
d. when said laser outputting passes over said unstable working area to said stable working area, said corresponding one of said reaction time values is a constant value, and compensation stops and normal energy output is maintained.
